(19) United States
(12) Patent Application Publication
(10) Pub. No.: US 2010/0124276 A1
(43) Pub. Date: May 20, 2010

(54) METHOD AND APPARATUS FOR DETECTING VIDEO FIELD SEQUENCE

(76) Inventor: Hailin ZHOU, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/619,177

(22) Filed: Nov. 16, 2009

(30) Foreign Application Priority Data
Nov. 18, 2008 (CN) 200810217805.6

(51) Int. Cl. H04N 7/32

(52) U.S. Cl. 375/240.12; 375/E07.243

(57) ABSTRACT

A method and apparatus for detecting a video field sequence and a video processing system are provided. The method includes: calculating a difference D1 between a top field Tn of a current frame and a bottom field Bₙ₋₁ of a previous frame and a difference D2 between a bottom field Bₙ of the current frame and a top field Tₙ₋₁ of the previous frame; and determining a displaying sequence of the top field and bottom field of the current frame by comparing D1 and D2.

### CROSS-REFERENCE TO RELATED APPLICATION

This application claims priority to Chinese Patent Application No. 200810217805.6 filed on Nov. 18, 2008, which is hereby incorporated by reference in its entirety.

### TECHNICAL FIELD

The present disclosure relates to video technology, and in particular, to a method and apparatus for detecting a video field sequence and a video processing system.

### BACKGROUND

Video streams exist in the form of frames after being restored to picture sequences by a decoder. If a video source is interlaced or is formed through field interleaving of a progressive source, for example, through frame rate conversion, two fields must be displayed in a same sequence as the video source when a frame is displayed on an interlaced device; otherwise, obvious high-frequency jitters may occur, which affects the subjective feeling. If a stream does not include field sequence information or the included field sequence information is unreliable, when the video is displayed on the interlaced device, the field displaying sequence can be determined only by other means, for example, by judging whether the top field is displayed first or the bottom field is displayed first.

A method for determining the field sequence in the prior art uses a general practice in the industry. For example, for Phase Alternating Line (PAL) streams, the top field is displayed first; for National Television System Committee (NTSC) streams, the bottom field is displayed first. Another method in the prior art uses the encoding and decoding information to reversely deduce the field sequence. For example, a picture order count (POC) reflects the time sequence of the picture over the H.264 protocol. If an interlaced source is encoded by field coding, the POCs of two fields of a frame also reflect the displaying sequence of the interlaced source. Thus, the POC may be used to deduce the field sequence.

### SUMMARY

A method for detecting a video field sequence according to an embodiment of the present disclosure includes:

calculating a difference D1 between a top field Tₙ of a current frame and a bottom field Bₙ₋₁ of a previous frame and a difference D2 between a bottom field Bₙ of the current frame and a top field Tₙ₋₁ of the previous frame; and

determining a displaying sequence of the top field and bottom field of the current frame by comparing D1 and D2.

An apparatus for detecting a video field sequence according to an embodiment of the present disclosure includes:

a difference calculating module, configured to calculate a difference D1 between a top field Tₙ of a current frame and a bottom field Bₙ₋₁ of a previous frame and a difference D2 between a bottom field Bₙ of the current frame and a top field Tₙ₋₁ of the previous frame; and

a field sequence detecting module, configured to determine a displaying sequence of the top field and bottom field of the current frame by comparing D1 and D2.

A video processing system according to an embodiment of the present disclosure includes:

a decoding module, configured to decode a video stream into multiple frames;

a difference calculating module, configured to calculate a difference D1 between a top field Tn of a current frame and a bottom field Bn−1 of a previous frame and a difference D2 between a bottom field Bn of the current frame and a top field Tn−1 of the previous frame;

a field sequence detecting module, configured to determine a displaying sequence of the top field and bottom field of the current frame by comparing D1 and D2; and

a displaying and outputting module, configured to output the top field and bottom field data of the current frame for displaying according to the displaying sequence determined by the field sequence detecting module.

### BRIEF DESCRIPTION OF THE DRAWINGS

The accompanying drawings illustrate some embodiments of the present disclosure. Evidently, the accompanying drawings are exemplary, and those skilled in the art can derive other drawings from the accompanying drawings without creative work.

FIG. 1 is a flowchart of a method for detecting a video field sequence according to an embodiment of the present disclosure;

FIG. 2 shows a structure schematics of an apparatus for detecting a video field sequence according to an embodiment of the present disclosure;

FIG. 3 shows a structure schematics of an apparatus for detecting a video field sequence according to another embodiment of the present disclosure; and

FIG. 4 shows a structure schematics of a video processing system according to an embodiment of the present disclosure.

### DETAILED DESCRIPTION

Embodiments of the present disclosure are hereinafter described in detail with reference to the accompanying drawings. It is evident that the embodiments are only exemplary embodiments of the present disclosure and the present disclosure is not limited to such embodiments. Other embodiments that those skilled in the art obtain based on embodiments of the present disclosure may also fall in the scope of protection of the present disclosure.

By using general practice to determine the field sequence in the prior art, most streams may be displayed properly even if no field sequence information is available. This practice is of some value with respect to being a reference but is not a mandatory regulation. There are still a large quantity of streams does not comply with this practice, and jitters may occur when these streams are displayed.

The other method mentioned above in the prior art is based on the assumptions that the interlaced source use field coding and that the POC values of the fields increase in a same sequence as the displaying sequence. Considering the general practice and encoding efficiency, the preceding assumptions are reasonable. However, no regulation specifies that the encoder must comply with the assumptions. Thus, this method may be implemented only to some extent, but for a lot of streams a correct field sequence cannot be obtained through this method.

The two methods for determining the field sequence in prior art are not reliable enough and may often cause misjudgment. In case of misjudgment, the subjective quality of videos may be seriously affected.

A method for detecting a video field sequence provided in an embodiment of the present disclosure is not based on any assumption. In this method, a difference between the top field and the bottom field of two adjacent frames is calculated according to the video content, and then the displaying sequence of the video frames is determined according to the difference; for example, the top field or the bottom field is determined to be displayed first. Thus, this method ensures that a correct displaying sequence may be obtained for videos encoded in various forms. A frame of a video consists of two fields. The displaying sequence or output sequence of the two fields is called a field sequence.

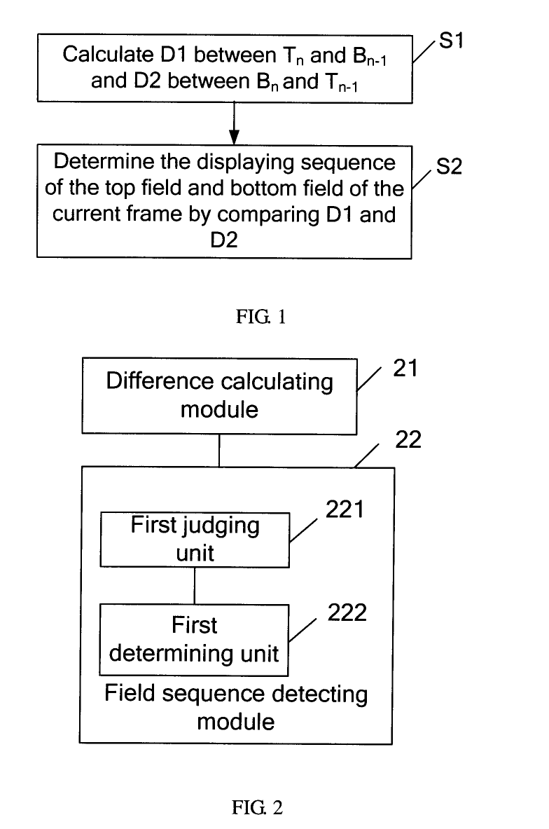

FIG. 1 is a flowchart of a method for detecting a video field sequence according to an embodiment of the present disclosure. The method includes the following steps:

S1: A difference D1 between the top field of a current frame and the bottom field of a previous frame and a difference D2 between the bottom field of the current frame and the top field of the previous frame are calculated.

The difference is used to measure the inconsistency between the two fields due to motions. For an interlaced video, each frame consists of a top field and a bottom field, where the top field is formed by odd lines (for example, lines 1, 3, 5 . . . ) and the bottom field is formed by even lines (for example, lines 2, 4, 6 . . . ). A time difference generally exists between the top field and the bottom field of a same frame; that is, either the top field is displayed first or the bottom field is displayed first. Similarly, among fields that are displayed by time in two adjacent frames, the difference between two fields with a closer time distance is smaller, while the difference between two fields with a farther time distance is bigger. For example, if f1, f2, f3 and f4 are fields displayed by time, the difference between f2 and f3 is generally small, while the difference between f1 and f4 is large.

A lot of methods may be used to represent the difference. For example, in a picture frame formed by interleaving two fields, if a pixel and its adjacent upper and lower pixels belong to different objects, the pixel is called an interlacing point. The more the interlacing points are, the larger the difference between the two fields is, and vice versa. Suppose: a decoded current frame is represented by Fₙ; the previous frame is represented by Fₙ₋₁; the top field of Fₙ₋₁ is represented by Tₙ₋₁; the bottom field of Fₙ₋₁ is represented by Bₙ₋₁; similarly, the top field and bottom field of Fₙ are represented by Tₙ and Bₙ.

The process of calculating D1 between Tₙ and Bₙ₋₁ includes: calculating the number N1 of interlacing points of picture frame formed by interleaving Tₙ and Bₙ₋₁.

The process of calculating D2 between Bₙ and Tₙ₋₁ includes: calculating the number N2 of interlacing points of picture frame formed by interleaving Bₙ and Tₙ₋₁.

Another method for representing the difference is to calculate the Sum of Absolute Difference (SAD) between two fields. The method for representing the difference by using the SAD is described in detail as follows.

First, a top field representative point set and a bottom field representative point set of a picture frame are defined. A frame is formed by two fields (a top field and a bottom field) that are mutually interleaved. Suppose N points are selected in the top field to form the top field representative point set, as shown in formula (1):

Sₜ={(xₜₖ,yₜₖ)|0≦xₜₖ<w,0≦yₜₖ<h−2,yₜₖ=an even number, k=0,1, . . . N−1} (1)

Similarly, N points corresponding to the points of Sₜ are selected in the bottom field to form the bottom field representative point set, as shown in formula (2):

S_{b}={(x_{bk},y_{bk})|x_{bk}=xₜₖ,y_{bk}=yₜₖ+1,k=0,1, . . . N−1} (2)

In formulas (1) and (2), (x_{bk}, y_{bk}) indicates a bottom field pixel coordinate; “w” indicates the width of the picture frame; and “h” indicates the height of the picture frame. The origin of the coordinates is located at the upper left corner of the picture frame; the right direction indicates the x axis, and the top-down direction indicates the y axis. In the top field representative set, “yₜₖ” is an even number, representing picture lines that have the y-axis values such as yₜₖ=0, 2, 4, 6 . . . , which correspond to the odd lines (i.e. lines 1, 3, 5 . . . , h−2) of the picture frame. Similarly, in the bottom field representative set, “y_{bk}=yₜₖ+1” represents picture lines that have the y-axis values such as y_{bk}=1, 3, 5 . . . , which correspond to the even lines (that is, lines 2, 4, 6 . . . h−1) of the picture frame. Suppose that the height of the picture frame is eight pixels, namely, eight lines, and that the y-axis value is equal to 0, 1, 2, 3, 4, 5, 6, 7, and 8. The picture lines corresponding to the even values of y=0, 2, 4, 6, 8 form the top field, while the picture lines corresponding to the odd values of y=1, 3, 5, 7 form the bottom field.

The selection of the top field representative point set Sₜ and the bottom field representative point set S_{b} usually is subject to selecting pixels that can cover a Region Of Interest (ROI) of a picture, where the number N of pixels in the representative point set is an integer greater than 1. As for the judgment of each frame, the number and location of pixels in the top field representative set and the bottom field representative set may be changed as occasion requires or according to the picture content. The point set capacity N may be adjusted according to allowable quantity of calculations. If the value of N is large, a more accurate result may be obtained, but a large quantity of calculations is required.

Suppose: a decoded current frame is represented by Fₙ, and the previous frame is represented by Fₙ₋₁; the top field of Fₙ₋₁ is represented by Tₙ₋₁, and the bottom field of Fₙ₋₁ is represented by Bₙ₋₁; the top and bottom fields of Fₙ are represented by Tₙ and Bₙ; the luminance values of N pixels of Fₙ₋₁ in Sₜ are represented by cₜₖ, and the luminance values of N pixels in S_{b} are represented by c_{bk}; similarly, the luminance values of pixels of Fₙ in Sₜ and S_{b} are represented by fₜₖ and f_{bk} respectively, where k=0, 1, 2, . . . N−1.

The calculations are defined as follows:

$$\begin{matrix}D 1 = SAD 1 = \vert {B}_{n - 1} - {T}_{n} \vert = {\sum }_{k = 0}^{N - 1} \vert {c}_{bk} - {f}_{tk} \vert & ( 3 ) \\ D 2 = SAD 2 = \vert {T}_{n - 1} - {B}_{n} \vert = {\sum }_{k = 0}^{N - 1} \vert {c}_{tk} - {f}_{bk} \vert & ( 4 )\end{matrix}$$

Where |Bₙ₋₁-Tₙ| indicates the difference between Bₙ₋₁ and Tₙ. Similarly, |Tₙ₋₁-Bₙ| indicates the difference between Tₙ₋₁ and Bₙ.

S2: The displaying sequence of the top field and bottom field of the current frame is determined by comparing D1 and D2.

Because fields of the video picture frame are samples of objective scenarios, the longer the time distance is, the bigger the content difference between the fields will be, and vice versa. If the field sequence is “top field first”, that is, if the top field is to be displayed before the bottom field in a same frame, the four fields of Fₙ₋₁ and Fₙ are displayed in the following sequence: Tₙ₋₁, Bₙ₋₁, Tₙ, and Bₙ. Thus, the difference D1 between Bₙ₋₁ and Tₙ, should be smaller than the difference D2 between Tₙ₋₁ and Bₙ. In other words, the similarity between Bₙ₋₁ and Tₙ should be greater than that between Tₙ₋₁ and Bₙ, as illustrated by the following formula:

If the top field is displayed first, then:

P(|Tₙ₋₁−Bₙ|−|Bₙ₋₁−Tₙ|>0)>0.5 (5)

Formula (5) is equivalent to P (D2>D1)>0.5, where P(X) indicates the probability of X.

Similarly, if the field sequence is “bottom field first”, that is, if the bottom field is displayed before the top field in a same frame, the four fields of Fₙ₋₁ and Fₙ are displayed in the following sequence: Bₙ₋₁, Tₙ₋₁, Bₙ, and Tₙ. Thus, D1 between Bₙ₋₁ and Tₙ should be greater than D2 between Tₙ₋₁ and Bₙ. In other words, the similarity between Bₙ₋₁ and Tₙ should be smaller than that between Tₙ₋₁ and Bₙ, as illustrated by the following formula::

If the bottom field is displayed first, then:

P(|Tₙ₋₁−Bₙ|−|Bₙ₋₁−Tₙ|<0)<0.5 (6)

Formula (6) is equivalent to P (D2>D1)>0.5, where P(X) indicates the probability of X.

In conclusion, the field sequence is related to the cross difference between the top field and the bottom field of two adjacent frames. Thus, the field sequence can be determined by measuring and comparing the cross difference. A method for determining the field sequence includes:

determining that the displaying sequence of the current frame is “top field first” (that is, top field of the current frame is to be displayed first), if the difference D1 between Tₙ and Bₙ₋₁ is smaller than the difference D2 between Bₙ and Tₙ₋₁; or

determining that the displaying sequence of the current frame is “bottom field to be displayed first” (that is, bottom field of the current frame is to be displayed first), if the difference D1 between Tₙ and Bₙ₋₁ is greater than the difference D2 between Bₙ, and Tₙ₋₁.

If D1 between Tₙ and Bₙ₋₁ is equal to D2 between Bₙ and Tₙ₋₁, the field sequence of the previous frame may be used as the field sequence detection result of the current frame, or the field sequence may be determined according to the general practice in the industry.

If the difference is represented by SAD, D1 and D2 may be SAD1 and SAD2. If the difference is represented by the number of interlacing points, D1 and D2 may be N1 and N2 mentioned before.

The difference mentioned in the embodiments of the present disclosure is calculated based on video contents. The field displaying sequence of the current frame is determined according to the difference between fields of two adjacent frames, without depending on any assumption or guess, thus greatly improving the accuracy and reliability of the field sequence detection.

The preceding formulas (5) and (6) are derived from the perspective of probabilities. In most cases, video frames comply with such probabilities described in formulas (5) and (6). However, in actual picture sequences, there may be some uncertainties for two frames due to influences of various factors. For example, a single frame may be affected by scenario changes and encoding noises, and thus does not comply with the probabilities. To further improve the accuracy and reliability of the field sequence detection, the difference among multiple frames may be calculated, and an overall rule may be obtained from the calculating result of each frame.

Specifically, the following calculation may be executed after D1 and D2 are calculated: SumDiff=SumDiff+(D2−D1). That is, the value of D2 minus D1 is added to a predetermined variable “SumDiff”, the initial value of which may be set to 0 or other numerical values. After calculating results of multiple frames are accumulated, the calculating results are used as the basis for detecting the field sequence of latter frames. A threshold “Thr” may be set to determine the field sequence according to the following conditions:

if SumDiff>Thr, it is determined that the displaying sequence of the current frame is “top field first”; or

if SumDiff<(−1)*Thr, it is determined that the displaying sequence of the current frame is “bottom field first”; or

if “SumDiff” does not meet the preceding two conditions, it is determined that the displaying sequence of the current frame is the same as that of the previous frame, or the field sequence may be determined according to the general practice in the industry;

where “Thr” is a predetermined threshold. The preceding accumulated value may also be D1 minus D2 (D1−D2), but the judgment condition needs to be changed accordingly.

The following provides an embodiment in which multiple frames are calculated successively; the difference is still represented by SAD; and an accumulator “SadDiffAcc” with the initial value 0 is defined. The following calculations are executed on each decoded frame:

SadDiffAcc=SadDiffAcc+(SAD2−SAD1), that is

SadDiffAcc=SadDiffAcc+(|Tₙ₋₁−Bₙ|−|Bₙ₋₁−Tₙ|)

Then, the condition for determining that the video field sequence is “top field first” is changed as follows:

SadDiffAcc>thr (7)

Contrarily, the condition for determining that the video field sequence is “bottom field first” is changed as follows:

SadDiffAcc<(−1)*thr (8)

wherein “thr” is a predetermined threshold.

A specific example is given below. Suppose: the initial value of “SadDiffAcc” is 0; thr=80; and there are four frames, namely, F1, F2, F3, and F4; the cross difference between F1 and F2 is 100; the cross difference between F2 and F3 is −150; and the cross difference between F3 and F4 is −10.

For F2, if SadDiffAcc=0+100=100>80, the field sequence of F2 is “top field first”.

For F3, if SadDiffAcc=100+(−150)=−50, which falls in the range of −80 to 80, the field sequence of F3 is the same as that of F2, or the field sequence is determined according to the general practice in the industry.

For F4, if SadDiffAcc=−50+(−40)=−90<−80, the field sequence of F4 is “bottom field first”.

If the difference is represented by the number of interlacing points, D1 and D2 only need to be changed to the preceding N1 and N2, while other steps are similar.

In this embodiment, the cross difference between the top field and the bottom field of two adjacent frames is accumulated, which can restrain the uncertainty of a single frame. Thus, the calculating results that reflect the overall rule may appear as more and more frames are calculated, which can be used to improve the accuracy and reliability of the field sequence detection.

In conclusion, in this embodiment, the field sequence information is extracted from the content of the video picture, which fundamentally solves the problem of inability to detect the field sequence reliably. In addition, the field sequence detection method in this embodiment does not destroy the video motion information, nor does it interrupt the playing continuity of the video. Furthermore, the calculation overheads may be controlled flexibly and the quantity of calculations may be minimized.

It is understandable to those skilled in the art that all or part of the processes of the method in the preceding embodiments of the present disclosure may be completed by hardware instructed by a computer program. The program may be stored in a computer readable storage medium, and may include processes of the preceding method during execution. The storage medium may be a magnetic disk, a compact disk (CD), a read-only memory (ROM) or a random access memory (RAM). One embodiment of the present disclosure provides a

As shown in FIG. 2, an apparatus for detecting a video field sequence according to an embodiment of the present disclosure includes:

a difference calculating module 21, configured to calculate a difference D1 between the top field Tn of the current frame and the bottom field Bn−1 of the previous frame and a difference D2 between the bottom field Bn of the current frame and the top field Tn−1 of the previous frame; and

a field sequence detecting module 22, configured to determine the displaying sequence of the top field and bottom field of the current frame by comparing D1 and D2 obtained by the difference calculating module 21.

The field sequence detecting module 22 may include:

a first judging unit 221, configured to judge the difference between D1 and D2; and

a first determining unit 222, configured to determine that the displaying sequence of the current frame is “top field first” if the first judging unit determines that D1 is smaller than D2, or determine that the displaying sequence of the current frame is “bottom field first” if the first judging unit 221 determines that D1 is greater than D2.

The apparatus for detecting a video field sequence in this embodiment calculates a difference according to video contents, and determines the field displaying sequence of the current frame according to the difference between fields of two adjacent frames, without depending on any assumption or guess, thus greatly improving the accuracy and reliability of the field sequence detection.

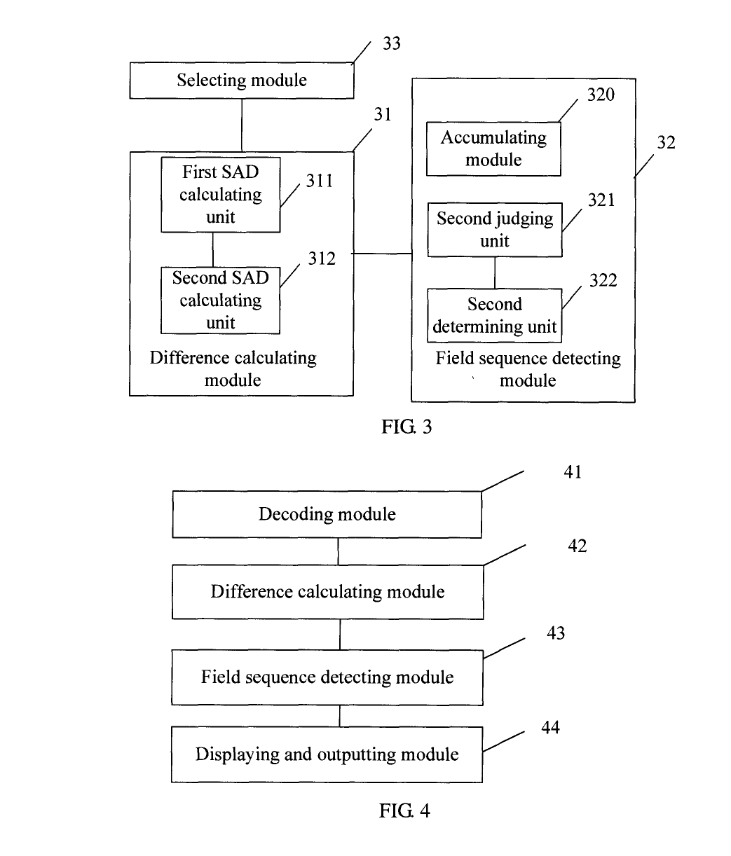

FIG. 3 shows a structure of an apparatus for detecting a video field sequence according to another embodiment of the present disclosure. The apparatus includes:

a difference calculating module 31, configured to calculate a difference D1 between the top field Tₙ of the current frame and the bottom field Bn−1 of the previous frame and a difference D2 between the bottom field Bn of the current frame and the top field Tn−1 of the previous frame;

a field sequence detecting module 32, configured to determine the displaying sequence of the top field and bottom field of the current frame by comparing D1 and D2 obtained by the calculating module 31; and

a selecting module 33, configured to: select N points in the top field and bottom fields of the current frame respectively to form a top field representative point set Sₜ and a bottom field representative point set S_{b} of the current frame, where N points of the Sₜ correspond to N points of the S_{b}; and select N points corresponding to the current frame in the top field and bottom field of the previous frame respectively to form a top field representative point set Sₜ and a bottom field representative point set S_{b} of the previous frame, where N is an integer greater than 1.

The difference calculating module 31 includes:

a first SAD calculating unit 311, configured to calculate SAD1 between the top field representative set of the current frame and the bottom field representative set of the previous frame;

a second SAD calculating unit 312, configured to calculate SAD2 between the bottom field representative set of the current frame and the top field representative set of the previous frame.

If the difference is represented by the number of interlacing points, each of which indicates a pixel point belonging to an object different from that of its adjacent upper and lower pixels in a picture frame obtained by interleaving two fields, the difference calculating module 31 is configured to: calculate the number N1 of interlacing points of a picture frame formed by interleaving Tₙ and Bₙ₋₁ as D1, and calculate the number N2 of interlacing points of a picture frame formed by interleaving Bₙ, and Tₙ₋₁ as D2.

The field sequence detecting module 32 includes:

an accumulating module 320, configured to add the difference value between D2 obtained by the difference calculating module 31 and D1 obtained by the difference calculating module 31 to the value of a predetermined variable “SumDiff”;

a second judging unit 321, configured to judge the difference between “SumDiff” obtained by the accumulating module 320 and a predetermined threshold “Thr”; and

a second determining unit 322, configured to: determine that the displaying sequence of the current frame is “top field first” when the second judging unit 321 determines that “SumDiff” is greater than “Thr”, or determine that the displaying sequence of the current frame is “bottom field first” when the second judging unit 321 determines that “SumDiff” is smaller than (−1)*Thr, or determine that the displaying sequence of the current frame is the same as that of the previous frame when the second judging unit 321 determines that “SumDiff” does not meet the preceding two conditions.

In this embodiment, the cross difference between the top field and the bottom field of two adjacent frames is accumulated, which can restrain the uncertainty of a single frame. Thus, the calculating results reflecting the overall rule may appear as more and more frames are calculated, which can be used to further improve the accuracy and reliability of the field sequence detection.

As shown in FIG. 4, a video processing system according to an embodiment of the present disclosure includes:

a decoding module 41, configured to decode a video stream into multiple frames;

a difference calculating module 42, configured to calculate a difference D1 between the top field Tn of the current frame and the bottom field Bn−1 of the previous frame and a difference D2 between the bottom field Bn of the current frame and the top field Tn−1 of the previous frame, where the current frame and previous frame are obtained by the decoding module 41;

a field sequence detecting module 43, configured to determine the displaying sequence of the top field and bottom field of the current frame by comparing D1 and D2; and

a displaying and outputting module 44, configured to output the top field and bottom field data for displaying according to the displaying sequence determined by the field sequence detecting module 43.

The difference calculating module 42 and the field sequence detecting module 43 are similar to those in the preceding apparatus embodiment.

In the video processing system in this embodiment of the present disclosure, the decoding module 41 obtains multiple frames by encoding a video data; the difference calculating module 42 calculates field differences by using the contents of two adjacent frames obtained by encoding; the field sequence detecting module 43 determines the displaying sequence of the current frame according to the field differences; and the displaying and outputting module 44 displays the fields of the frames according to the determined field sequence. Thus, the problem of inability to detect the field sequence reliably is solved, and the subjective quality of pictures is improved.

The method for detecting field sequence in present disclosure may be implemented by the apparatus provided in present disclosure. The apparatus may be a decoder, and the video processing system may include the decoder.

The present disclosure has been described through some exemplary embodiments and accompanying drawings. However, the scope of the disclosure should not be limited to such embodiments. It is apparent that those skilled in the art can make various modifications and variations to the disclosure without departing from the spirit and scope of the disclosure.

What is claimed is:

1. A method for detecting a video field sequence, comprising:
calculating a difference D1 between a top field Tₙ of a current frame and a bottom field Bₙ₋₁ of a previous frame and a difference D2 between a bottom field Bₙ of the current frame and a top field Tₙ₋₁ of the previous frame; and
determining a displaying sequence of the top field and bottom field of the current frame by comparing D1 and D2.

2. The method according to claim 1, wherein, determining the displaying sequence of the top field and bottom field of the current frame by comparing D1 and D2 comprises:
determining that the displaying sequence of the current frame is top field to be displayed first if the difference D1 between the top field Tₙ of the current frame and the bottom field Bₙ₋₁ of the previous frame is smaller than the difference D2 between the bottom field Bₙ₋₁ of the current frame and the top field Tₙ₋₁ of the previous frame; or
determining that the displaying sequence of the current frame is bottom field to be displayed first if the difference D1 between Tₙ and Bₙ₋₁ is greater than the difference D2 between Bₙ and Tₙ₋₁; or
determining that the displaying sequence of the current frame is the same as that of the previous frame.

3. The method according to claim 1, wherein:
the difference D1 or D2 is represented by a Sum of Absolute Difference (SAD);
calculating a difference D1 between the top field of a current frame and the bottom field of a previous frame and a difference D2 between the bottom field of the current frame and the top field of the previous frame comprises:
calculating a Sum of Absolute Difference 1 (SAD1), between a top field representative point set Sₜ of current frame and a bottom field representative point set S_{b} of previous frame;
calculating a Sum of Absolute Difference 2 (SAD2), between the a bottom field representative point set S_{b} of current frame and a top field representative point set Sₜ of previous frame; and
the field representative point set is a set of several pixels selected from the field that that cover a Region Of Interest (ROI) of a picture.

4. The method according to claim 3, wherein selecting the field representative point set comprises:
selecting N points in the top field and bottom fields of the current frame respectively to form the top field representative point set Sₜ and the bottom field representative point set S_{b} of the current frame, wherein N points of the Sₜ correspond to N points of the S_{b}, and N is an integer greater than 1; or
selecting N points corresponding to the current frame in the top field and bottom field of the previous frame respectively to form the top field representative point set Sₜ and the bottom field representative point set S_{b} of the previous frame, wherein N is an integer greater than 1.

5. The method according to claim 1, further comprising:
accumulating a difference value between D2 and D1 to a predetermined variable “SumDiff”;
wherein determining the displaying sequence of the top field and bottom field of the current frame by comparing D1 and D2 comprises:
determining that the displaying sequence of the current frame is top field to be displayed first if the comparing result is SumDiff>Thr; or
determining that the displaying sequence of the current frame is bottom field to be displayed first if the comparing result is SumDiff<(−1)*Thr; or
determining that the displaying sequence of the current frame is the same as that of the previous frame if “SumDiff” does not meet the preceding two conditions; wherein
Thr is a predetermined threshold.

6. The method according to claim 1, wherein,
the difference D1 or D2 is represented by a number of interlacing points, and a pixel is called an interlacing point if the pixel and its adjacent upper and lower pixels belong to different objects in a picture frame formed by interleaving two fields; calculating a difference D1 between the top field of a current frame and the bottom field of a previous frame and a difference D2 between the bottom field of the current frame and the top field of the previous frame comprises:
calculating a number N1 of interlacing points of the picture frame formed by interleaving the bottom field of current frame and the top field of previous frame; and
calculating a number N2 of interlacing points of the picture frame formed by interleaving the bottom field of current frame and the top field of previous frame.

7. An apparatus for detecting a video field sequence, comprising:
a difference calculating module, configured to calculate a difference D1 between a top field Tₙ of a current frame and a bottom field Bₙ₋₁ of a previous frame and a difference D2 between a bottom field Bₙ of the current frame and a top field Tₙ₋₁ of the previous frame; and
a field sequence detecting module, configured to determine the displaying sequence of the top field and bottom field of the current frame by comparing D1 and D2 obtained by the difference calculating module.

8. The apparatus according to claim 7, wherein the field sequence detecting module comprises:
a first judging unit, configured to judge a difference between D1 and D2; and
a first determining unit, configured to:
determine that the displaying sequence of the current frame is top field to be displayed first if the first judging unit determines that D1 is smaller than D2; or
determine that the displaying sequence of the current frame is bottom field to be displayed first if the first judging unit determines that D1 is greater than D2; or
determine that the displaying sequence of the current frame is the same as that of the previous frame if the first judging unit determines that D1 equals D2.

9. The apparatus according to claim 7, wherein
the difference D1 or D2 is represented by a Sum of Absolute Difference (SAD), and the difference calculating module comprises:
a first SAD calculating unit, configured to calculate a first Sum of Absolute Difference (SAD1) between a top field representative set Sₜ of the current frame and a bottom field representative set S_{b} of the previous frame; and
a second SAD calculating unit, configured to calculate a second Sum of Absolute Difference (SAD2) between a bottom field representative set S_{b} of the current frame and a top field representative set Sₜ of the previous frame; and
the field representative point set is a set of several pixels selected from a field that that covers a Region Of Interest (ROI) of a picture.

10. The apparatus according to claim 9, further comprising:
a selecting module, configured to: select N points in the top field and bottom fields of the current frame respectively to form the top field representative point set Sₜ and the bottom field representative point set S_{b} of the current frame, wherein N points of the Sₜ correspond to N points of the S_{b}; and select N points corresponding to the current frame in the top field and bottom field of the previous frame respectively to form the top field representative point set Sₜ and the bottom field representative point set S_{b} of the previous frame, wherein N is an integer greater than 1.

11. The apparatus according to claim 7, wherein, the field sequence detecting module comprises:
an accumulating module, configured to add a difference value between D2 and D1 obtained by the difference calculating module to a value of a predetermined variable “SumDiff”;
a second judging unit, configured to judge a difference between “SumDiff” obtained by the accumulating module and a predetermined threshold “Thr”; and
a second determining unit, configured to: determine that the displaying sequence of the current frame is “top field first” when the second judging unit determines that “SumDiff” is greater than “Thr”, or determine that the displaying sequence of the current frame is “bottom field first” when the second judging unit determines that “SumDiff” is smaller than (−1)*Thr, or determine that the displaying sequence of the current frame is the same as that of the previous frame when the second judging unit determines that “SumDiff” does not meet the preceding two conditions.

12. The apparatus according to claim 7, wherein
the difference D1 or D2 is represented by a number of interlacing points, wherein a pixel is called an interlacing point if the pixel and its adjacent upper and lower pixels belong to different objects in a picture frame formed by interleaving two fields; and
the difference calculating module is configured to calculate a number N1 of interlacing points of the picture frame formed by interleaving the bottom field of current frame and the top field of previous frame, and calculate a number N2 of interlacing points of the picture frame formed by interleaving the bottom field of current frame and the top field of previous frame.

13. A video processing system, comprising:
a decoding module, configured to decode a video stream into multiple frames;
a difference calculating module, configured to calculate a difference D1 between a top field Tₙ of a current frame and a bottom field Bₙ₋₁ of a previous frame and a difference D2 between a bottom field Bₙ of the current frame and a top field Tₙ₋₁ of the previous frame, wherein the current frame and the previous frame are obtained by the decoding module;
a field sequence detecting module, configured to determine a displaying sequence of the top field and bottom field of the current frame by comparing D1 and D2; and
a displaying and outputting module, configured to output the top field and bottom field data for displaying according to the displaying sequence determined by the field sequence detecting module.

14. The system according to claim 13, wherein the field sequence detecting module comprises:
a judging unit, configured to judge a difference between D1 and D2; and
a determining unit, configured to determine that the displaying sequence of the current frame is top field to be displayed first if the judging unit determines that D1 is smaller than D2; or
determine that the displaying sequence of the current frame is bottom field to be displayed first if the judging unit determines that D1 is greater than D2; or
determine that the displaying sequence of the current frame is the same as that of the previous frame if the judging unit determines that D1 is equal to D2.

15. A computer-readable medium having computer usable instructions stored thereon for execution by one or more processors to perform a method comprising:
calculating a difference D1 between a top field Tₙ, of a current frame and a bottom field Bₙ₋₁ of a previous frame and a difference D2 between a bottom field Bₙ, of the current frame and a top field Tₙ₋₁ of the previous frame; and
determining a displaying sequence of the top field and bottom field of the current frame by comparing D1 and D2.

16. The computer-readable medium according to claim 15, wherein determining the displaying sequence of the top field and bottom field of the current frame by comparing D1 and D2 comprises:
determining that the displaying sequence of the current frame is top field to be displayed first if the difference D1 between the top field Tₙ of the current frame and the bottom field Bₙ₋₁ of the previous frame is smaller than the difference D2 between the bottom field Bₙ of the current frame and the top field Tₙ₋₁ of the previous frame; or
determining that the displaying sequence of the current frame is bottom field to be displayed first if the difference D1 between Tₙ and Bₙ₋₁ is greater than the difference D2 between Bₙ and Tₙ₋₁; or
determining that the displaying sequence of the current frame is the same as that of the previous frame.

17. The computer-readable medium according to claim 15, wherein the difference D1 or D2 is represented by a Sum of Absolute Difference (SAD).

18. The computer-readable medium according to claim 15, wherein the difference D1 or D2 is represented by a number of interlacing points, and a pixel is called an interlacing point if the pixel and its adjacent upper and lower pixels belong to different objects in a picture frame formed by interleaving two fields.

19. The medium according to claim 15, wherein
the method further comprises: accumulating a difference value between D2 and D1 to a predetermined variable “SumDiff”;
determining the displaying sequence of the top field and bottom field of the current frame by comparing D1 and D2 comprises:
determining that the displaying sequence of the current frame is top field to be displayed first if the comparing result is SumDiff>Thr, wherein Thr is a predetermined threshold; or
determining that the displaying sequence of the current frame is bottom field to be displayed first if the comparing result is SumDiff<(−1)*Thr, wherein Thr is a predetermined threshold; or
determining that the displaying sequence of the current frame is the same as that of the previous frame if “SumDiff” does not meet the preceding two conditions.
